(19) United States
(12) Patent Application Publication
(10) Pub. No.: US 2009/0151210 A1
(43) Pub. Date: Jun. 18, 2009

(54) Sponsored escape guide indication board

(75) Inventor: Kimiaki Nagatome, Fukuyama-shi (JP)

Correspondence Address: JORDAN AND HAMBURG LLP, 122 EAST 42ND STREET, SUITE 4000, NEW YORK, NY, 10168, US

(73) Assignee: HIROSHIMA KASEI, LTD, Fukuyama-shi (JP)

(21) Appl. No.: 12/291,448

(22) Filed: Nov. 10, 2008

(30) Foreign Application Priority Data
Dec. 12, 2007 (JP) 2007-320819

(51) Int. Cl. G09F 13/00

(52) U.S. Cl. 40/541

(57) ABSTRACT

A sponsored escape guide indication board includes a light-storage guide sign plate that displays the escape guidance on a base plate disposed on a wall surface of a building structure, a light-storage identification sign plate that is located adjacent to the guide sign plate and displays identification information of the guide indication board, and a non-light-storage sponsor sign plate that is located at a distance from the identification sign plate and displays a mark of a sponsor of the disposition of the guide indication board. The sign plates are fit and mounted in recesses formed in the base plate. The identification sign plate is provided with an identifier readable by portable terminals and the portable terminals may acquire sponsor information at normal times or escape information at the time of disaster from a management server of the guide indication board through the identifier.

### CROSS-NOTING PARAGRAPH

This Nonprovisional application claims priority under 35 U.S.C. §119(a) on Patent Application No. 2007-320819 filed in JAPAN on Dec. 12, 2007, the entire contents of which are hereby incorporated herein by references.

### FIELD OF THE INVENTION

The present invention relates generally to an escape guide indication board disposed in building structures, including a light-storage guide sign plate displaying an emergency exit or exit and a direction of escape at the time of disaster. More particularly, the present invention relates to a sponsored escape guide indication board effective in improving the eye catching effect enhancing recognition of the presence of a guide sign plate at normal times as well as widely spreading and promoting the introduction of the sign plate.

### BACKGROUND OF THE INVENTION

Due to popularization of subways, expansion of underground cities and underground parking, and construction of large integrated buildings in recent years, it is important to dispose escape guide signs guiding and displaying exits or emergency exits for escaping to the outside at the time of disaster as one disaster prevention measure in these establishments.

Such an escape guide sign is generally disposed as a guide light with display of a guide sign illuminated from behind by an illumination lamp (backlight) as shown in FIG. 5. These guide lights have built-in batteries for emergency power sources of the backlight for power failure in an emergency.

The life of batteries for emergency power sources of the guide lights is generally 20 minutes (in the Building Standard Law of Japan) and the life of emergency lighting facilities is thirty minutes (same as above). If evacuation is not completed in these periods, people must grope their way and many human lives are put at risk. Lives of many people unable to escape were actually lost because the power source of the station house was lost in the subway vehicle fire accident in Seoul, Korea, 2003.

After this accident, disposition of escape guide signs particularly in underground space crowded with people such as subway becomes an issue and a light-storage escape guide sign attracts attention as a countermeasure in addition to the emergency power sources of guide lights when power sources are lost.

A light-storage escape guide sign has, for example, a resin layer mixed with a light-storage fluorescent substance formed on a surface of a base material such as an aluminum plate, and a guide sign is displayed on the surface of the resin layer to indicate a direction of escape with a thin green translucent film. As a result, if a power source is lost, the remaining light stored in the resin layer mixed with the light-storage fluorescent substance serves as backlight (backlight effect) to display a guide sign standing out and indicating a direction of escape. Japanese Laid-Open Patent Publication No. 2007-224680 discloses such a light-storage escape guide panel disposed on the aisle surface.

It is desired to dispose such light-storage escape guide signs in large-scale building structures such as station houses of subways, underground cities, underground parking, and large buildings for developing safe cities.

Assuming a disaster site with fire and full of smoke, the light-storage escape guide signs are requested to be disposed at intervals of 5 to 10 meters since the signs are not so bright as guide lights and are not visible from a long distance, a lot of escape guide signs must be disposed and, therefore, the economic burden discourages the disposition and promotion thereof.

It is also required that the signs are not obstacles to the crowds escaping in panic at the time of disaster and to the traffics of crowded pedestrians at normal times, that the disposed escape guide signs are well recognized by the crowds not only at the time of emergency but also at normal times and are useful for helping the people act safely in an emergency, and that the disposed escape guide signs are not easily removed or damaged and are easily maintained.

### SUMMARY OF THE INVENTION

The present invention provides a sponsored escape guide indication board disposed in such large-scale buildings in cities, including a light-storage guide sign.

An object of the present invention is to provide a sponsored escape guide indication board which is a guide indication board disposed on a wall surface of a building structure to display escape guidance, wherein the guide indication board comprises a light-storage guide sign plate that displays the escape guidance, a light-storage identification sign plate that displays identification information of the guide indication board, and a non-light-storage sponsor sign plate that displays a mark provided by a sponsor of the disposition of the guide indication board on a base plate; the base plate has three recesses for mounting the sign plates in a vertical arrangement on a flat front face when the guide indication board is disposed on the wall surface such that two of the recesses are formed adjacent to each other and the other one is formed at a predetermined interval; the recesses have mounting portions formed only in their bottom portions for disposing the guide indication board on the wall surface; further, the base plate has a rim formed as a curved surface and the rim is bent such that a rim end is in contact with the wall surface in the disposed state, the identification sign plate is located between the sign plates disposed in the recesses; the identification sign plate and the guide sign plate are located adjacent to each other; the sponsor sign plate is located at a distance; and the surfaces of the sign plates are recessed from the front face of the base plate.

Another object of the present invention is to provide the sponsored escape guide indication board, wherein the identification sign plate displays information indicating a disposition location of the guide indication board.

Another object of the present invention is to provide the sponsored escape guide indication board, wherein the identification sign plate is further provided with an identifier including at least the identification information such as a QR code (registered trademark) or an IC chip readable by portable terminals.

Another object of the present invention is to provide the sponsored escape guide indication board, wherein the identifier is an identifier to be read with portable terminals to give an instruction of connecting the portable terminals for communication with a disposition manager of the guide indication board.

Another object of the present invention is to provide the sponsored escape guide indication board, wherein the sponsor sign plate is removably mounted in the recess of the base plate.

### BRIEF DESCRIPTION OF THE DRAWINGS

FIG. 1 depicts a schematic of a sponsored escape guide indication board according to the present invention;

FIGS. 2A and 2B depict a configuration of a base plate of the guide indication board of the present invention;

FIG. 3 is an explanatory view of an embodiment of the present invention;

FIG. 4 is an explanatory flowchart of the embodiment of the present invention; and

FIG. 5 depicts a conventional escape guide light.

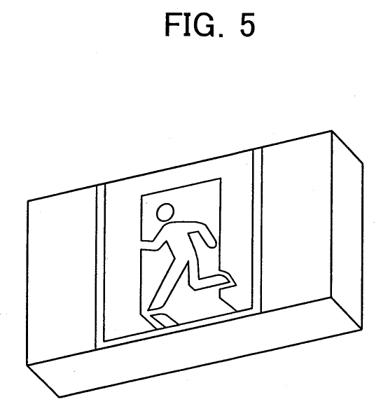

### PREFERRED EMBODIMENTS OF THE INVENTION

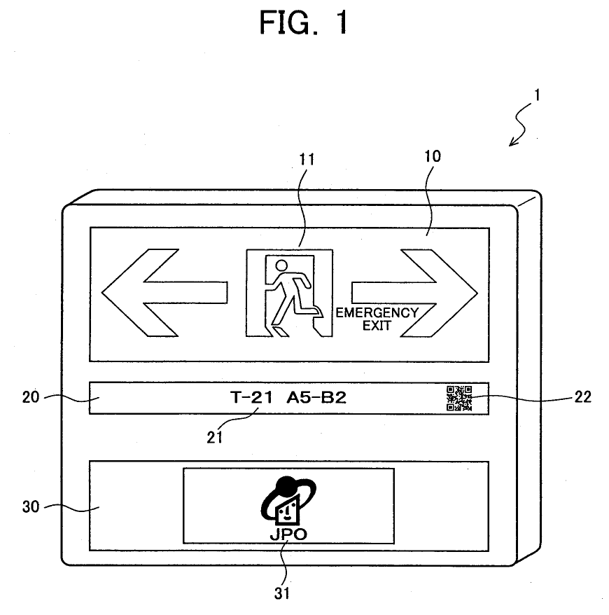

FIG. 1 depicts an arrangement relationship of a guide sign plate 10, an identification sign plate 20, and a sponsor sign plate 30 on a base plate of a sponsored escape guide indication board 1 according to the present invention. The example of FIG. 1 shows an example that the guide sign plate 10 is located on the upper side and when the guide indication board 1 is disposed on a wall and the identification sign plate 20 is located at the intermediate part adjacently to the guide sign plate.

The guide sign plate 10 displays an indication 11 of a guide sign indicating directions toward the location of the emergency exits, and the identification sign plate 20 displays unique identification information 21 identifying the guide indication board. The identification information 21 is correlated with a place of a building structure with the guide indication board disposed, the disposed position of the guide indication board in the building structure, etc., and is used for managing the guide indication board along with an identifier described later. The identification information 21 is displayed with reference characters to avoid confusion with the indication 11 of “EXIT emergency exit” of the guide sign plate in the example shown and sufferers may send the reference characters as an urgent message using portable terminals, etc., to acquire information of a safe escape route at the time of disaster.

Although it is also proposed to display or add the identification reference characters or identifiers displayed on the identification sign plate indicating the disposition location of the escape guide indication board onto the guide sign plate along with the guide sign displaying the directions of escape, it is prohibited to perform display other than escape guidance on the guide sign plates as a general rule in the “standard of guide lights and guide signs” defined in the Fire Defense Law and, therefore, such a proposition is substantially unfeasible. The guide sign plate 10 and the identification sign plate 20 are separately provided in view of this point.

The sponsor sign plate 30 is disposed on the lower part of the base plate at a predetermined interval from the guide sign plate 10 and the identification sign plate 20 related to the escape guidance. The sponsor sign plate 30 displays a mark such as a company logo 31 indicating a sponsor such as a company sponsoring the disposition of the guide indication board. Although Symbols confused with arrows, etc., displayed on the guide sign plate must be avoided of course, a guard space of a predetermined interval is also provided between the sign plate 30 and the identification sign plate 20 so as not to confuse the indication of the sign plate 30 with the indication 11 of the guide sign of the guide sign plate 10 or the indication 21 of the identification information of the identification sign plate.

Since the logo mark, etc., of the company sponsoring the disposition of the guide indication board is displayed on the guide indication board for the escape guidance along with the indication of the guide sign indicating the directions of escape such as “emergency exit” and the identification sign indicating the disposition location of the guide board such that these signs are not confused, the eye catching effect of the guide indication board is enhanced for pedestrians at normal times, which improves the recognition of the escape guidance at the time of emergency. As a result, since the learning effect for the guide indication of the guide sign may be achieved in pedestrians, people can escape following the guide indication of the guide sign in a calm manner without getting into a panic.

Although the guide sign and the identification sign necessary for escape are visually recognized by pedestrians at the time of emergency since the guide sign plate 10 and the identification sign plate 20 are made up of light-storage sign plates, a company logo mark, etc., unnecessary for escape are not visually recognized and are not obstacles to pedestrians when the lighting is lost since the sponsor sign plate 30 is made up of a non-light-storage sign plate.

The guide indication board may optionally be disposed with the sponsor sign plate on the upper side and the guide sign plate on the lower side.

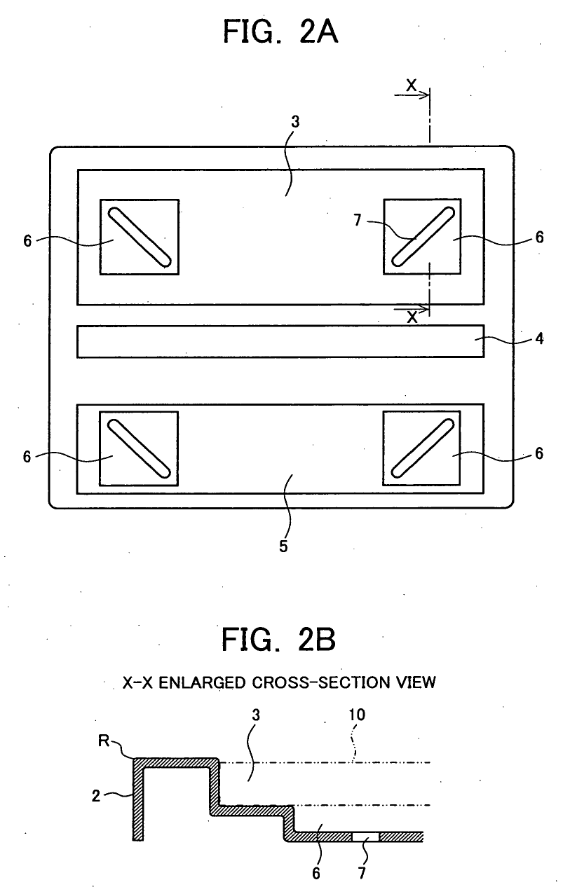

FIGS. 2A and 2B depict a configuration of the base plate of the escape guide indication board of the present invention, which is formed by the pressing process of a steel plate such as a stainless steel plate. The guide indication board is disposed on a wall such that the base plate is not easily removed and that pedestrians are not scratched and injured or that briefcases or bags are not scratched or hit and damaged when crowded since the board is slightly projected from the wall.

As shown in FIG. 2A, a rim 2 of the base plate is bent by the pressing process of a steel plate to form a curved surface R, and the end of the rim is in contact with a wall surface in the disposed state. The end of the rim may further be bent in a flange shape extending from the base plate rim and this increases the bending strength of the base plate. A recess 3 for mounting the guide sign plate 10 and a recess 4 for mounting the identification sign plate 20 are adjacently formed on the front face of the base plate, and a recess 4 for mounting the sponsor sign plate 30 is formed at a certain interval from the recess 4.

Mounting recesses 6 for screwing the guide indication board on a wall are formed in the mounting recess 3 of the guide sign plate and the mounting recess 5 of the sponsor sign plate, and slits 7 are formed for mounting screws in the recess. These mounting recesses 6 may be disposed in the mounting recess of the identification sign plate 20.

FIG. 2B is an enlarged cross-section view taken along line X-X of FIG. 2A; the end of the base plate rim and the bottom of the mounting recesses 6 are formed to contact with the disposition wall surface; and the mounting recesses of the sign plates are formed such that the surfaces of the sign plates are recessed from the surface of the base plate when the sign plates are mounted. Particularly, the guide sign plate 10 and the identification sign plate 20 are mounted such that no gap is formed between the rims thereof and the edges of the recesses.

Although the guide indication board is projected by about 1 cm from the wall surface when disposed in the embodiment shown, since the rim portion is formed in a curved shape and the sign plates are mounted to be recessed from the base plate surface, the guide indication board is configured not to be an obstacle to pedestrians when crowded as above. Since the mounting screw portions of the guide indication board and the wall surface are covered by the sign plates, the guide indication board cannot easily be removed. Particularly, the guide sign plate 10 and the identification sign plate 20 are mounted on the base plate with a strong binding material so as not to be easily removed. On the other hand, the sponsor sign plate 30 is removably mounted such that the plate may be changed when sponsor changes.

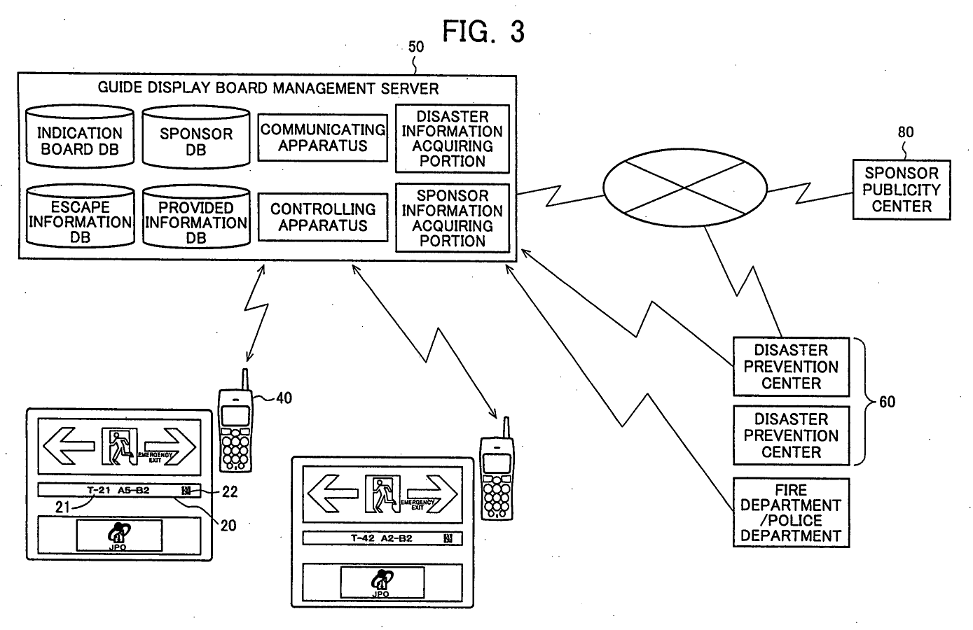

FIG. 3 is an explanatory view when an identifier 22 such as a QR code (registered trademark) or an IC chip is added to the identification sign plate 20. Although the unique identification information 21 identifying the guide indication board is displayed on the identification sign plate for the management of disposition of the guide indication board as well as the identification of the disposition location, etc., as described above, the identifier 22 such as a QR code (registered trademark) or an IC chip is also added that is readable by information terminals 40 such as portable telephones carried by pedestrians.

The identifier 22 retains at least identification information unique to the guide indication board as is the case with the identification reference characters and information indicating a communication destination to a disposition management server 50 of the guide indication board. When the identifier is read by the portable terminal 40, transmission and instruction is automatically made by a function of the portable terminal to connect the portable terminal 40 to the disposition management server 50 of the guide indication board to transmit the read identifier information.

Although the management server 50 may be located at a disaster prevention center of the building structure disposed with the guide indication board 1, the management server 50 is preferably disposed in a location independent from a disaster-affected building structure and may manage the disposed guide indication boards for each building structure or in a wide area. A reference number 60 denotes a department that comprehends disaster information, such as a disaster prevention center of the building structure disposed with the guide indication board, and disaster information is quickly collected and reported. The fire department and the police department play the same role. A reference number 80 denotes a publicity center, etc., of the sponsor.

One feature of the present invention is to promote the disposition of the expensive light-storage guide signs with collaboration from the sponsor under the situation requiring to dispose a plurality of the light-storage guide signs at intervals of 5 to 10 meters, and the guide indication board is provided with the sponsor sign plate to display the sponsor logo. Correspondingly, when the portable terminal 40 such as a portable telephone carried by a pedestrian is held closer to the identifier 22 to connect (access) to the management server 50 at normal times, information related to the sponsor of the disposition of the guide indication board is supplied to the portable terminal 40.

The management server 50 includes an indication board database (DB) that has recorded therein disposition locations, guide sign types, identification reference characters, etc., of the guide indication boards for each identifier; a sponsor DB that has recorded therein identifiers, sign logos, sponsored periods, etc., of the indication boards for each sponsor; a provided information DB that has recorded therein sponsor information of the guide indication board, local information such as local event, etc., for each identifier; an escape information DB that has recorded therein escape gates such as escapable exits and emergency exits, escape routes, etc., corresponding to the identifiers at the occurrence of disaster; a disaster information acquiring portion; a sponsor information acquiring portion; a communicating apparatus; and a controlling portion that controls these portions.

The escape information DB has stored therein the escape gate and escape route such as the nearest exit or emergency exit correspondingly to the identifier of the guide indication board at normal times, and the controlling portion selects, updates, and records the latest escape gate and escape route for each of the identifiers at the time of disaster based on information of a disaster occurring location and a progress situation of disaster.

When accessed by a portable terminal through the identifier of the guide indication board of the transmission source at normal times, the provided information DB preferentially provides information related to the sponsor that sponsors the disposition of the guide indication board. Information related to the disposition area of the guide indication board may arbitrarily be provided on this occasion.

The latest information is provided as the information related to the sponsor since the sponsor information acquiring portion periodically acquires information from a publicity center, etc., of the sponsor to update the provided information DB. The sponsor DB is updated based on a predetermined sponsor period (contract period).

When the disaster information acquiring portion acquires disaster information from the disaster prevention center, the fire department, the police department, etc., at the time of disaster, the controlling portion selects a safe escape gate and escape route avoiding the disaster occurring location for each identifier to correct and update the records in the escape information DB based on the disaster occurring location and the progress situation of disaster in the information. When accessed by a portable terminal, the occurrence of disaster is automatically announced and the latest escape gate and escape route are returned.

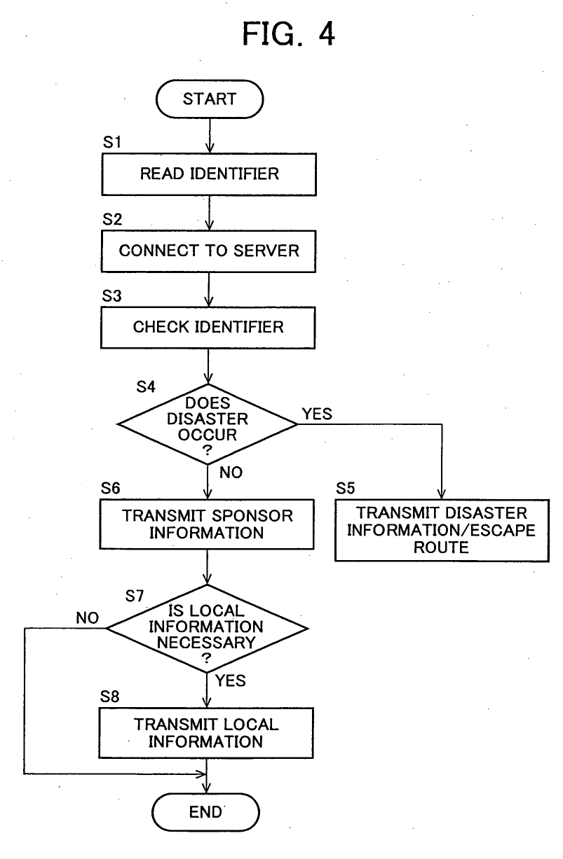

FIG. 4 is an explanatory flowchart of the process after a pedestrian holds the portable terminal 40 closer to the identification sign plate 20 to read the identifier 22. When the portable terminal 40 reads the identifier 22 at S1, transmission and connection to the management server 50 of the guide indication board are performed automatically or through an instruction of transmission by the program of the portable terminal at S2. When the server is connected and the identifier 22 is checked at S3, the building structure and the position information of the transmission source are identified in the indication board DB to check whether disaster information of the building structure is acquired at step S4. If the disaster information is acquired (S4, YES), the latest safe escape gate and escape route guide stored in the escape information DB are transmitted along with the disaster information.

If no disaster exists (S4, NO), information provided by the sponsor of disposition of the guide indication board with the identifier is first transmitted from the provided information DB, and it is questioned whether local information of events, shopping malls, etc., in the surrounding area of the building structure is desired to be acquired at S7; if necessary, the information is provided (S8); and if not necessary, transmission is accordingly performed to terminate the process.

The management server may optionally be connected to the internet to enable connection through access to the management server to a web site provided by the sponsor and a web site providing disaster information.

According to the present invention, the following effects may be acquired.

Since the sponsored escape guide indication board according to the present invention displays not only the escape guide as is the case with a conventional guide light but also the sponsor sign such as a logo mark indicating a company that sponsors the disposition of the guide indication board along with the escape guide, the recognition (eye catching effect) of the disposition of the escape guide sign is improved in crowds at normal times, which is useful for the calm escape behavior at the time of emergency.

Since the guide sign plate indicating the escape guidance and the identification sign plate identifying the disposition location, etc., of the guide indication board are light-storage sign plates while the sponsor sign plate is a non-light-storage sign plate, only the guide sign plate and the identification sign plate are recognized by the crowds due to the light storage effect when the electricity is cut at the time of emergency, and the sponsor sign plate become dark and does not act as an obstacle to the escape guidance at the time of emergency.

Since effects of enhancing CSR (corporate social responsibility) of the sponsor company and a company image due to contributions to local disaster prevention may also be expected by displaying the logo mark of the company sponsoring the disposition of the guide indication board on the sponsor sign plate, a promotional effect of disposition of the escape guide indication boards may be expected.

1. A sponsored escape guide indication board which is a guide indication board disposed on a wall surface of a building structure to display escape guidance, wherein
the guide indication board comprises a light-storage guide sign plate that displays the escape guidance, a light-storage identification sign plate that displays identification information of the guide indication board, and a non-light-storage sponsor sign plate that displays a mark provided by a sponsor of the disposition of the guide indication board on a base plate;
the base plate has three recesses for mounting the sign plates in a vertical arrangement on a flat front face when the guide indication board is disposed on the wall surface such that two of the recesses are formed adjacent to each other and the other one is formed at a predetermined interval;
the recesses have mounting portions formed only in their bottom portions for disposing the guide indication board on the wall surface; further,
the base plate has a rim formed as a curved surface and the rim is bent such that a rim end is in contact with the wall surface in the disposed state, the identification sign plate is located between the sign plates disposed in the recesses;
the identification sign plate and the guide sign plate are located adjacent to each other;
the sponsor sign plate is located at a distance; and
the surfaces of the sign plates are recessed from the front face of the base plate.

2. The sponsored escape guide indication board as defined in claim 1, wherein the identification sign plate displays information indicating a disposition location of the guide indication board.

3. The sponsored escape guide indication board as defined in claim 1 or 2, wherein the identification sign plate is further provided with an identifier including at least the identification information such as a QR code (registered trademark) or an IC chip readable by portable terminals.

4. The sponsored escape guide indication board as defined in claim 3, wherein the identifier is an identifier to be read with portable terminals to give an instruction of connecting the portable terminals for communication with a disposition manager of the guide indication board.

5. The sponsored escape guide indication board as defined in claim 4, wherein the sponsor sign plate is removably mounted in the recess of the base plate.
